(19) United States
(12) Patent Application Publication
(10) Pub. No.: US 2008/0077323 A1
(43) Pub. Date: Mar. 27, 2008

(54) NAVIGATION SYSTEM WITH RADIO TRANSMITTER

(75) Inventor: Lars Boysen, Hamburg (DE)

Correspondence Address: BLAKELY SOKOLOFF TAYLOR & ZAFMAN, 1279 OAKMEAD PARKWAY, SUNNYVALE, CA, 94085-4040, US

(73) Assignee: Navigon AG, Hamburg (DE)

(21) Appl. No.: 11/782,531

(22) Filed: Jul. 24, 2007

(30) Foreign Application Priority Data
Aug. 1, 2006 (DE) 20 2006 011 878.0

(51) Int. Cl. G01C 21/34

(52) U.S. Cl. 701/211

(57) ABSTRACT

The invention pertains to a portable navigation system (1) for a motor vehicle with a radio receiver (6), wherein the navigation system (1) comprises a device (3) for generating acoustic navigating instructions, wherein the navigation system (1) features a transmitting device (4) for generating radio signals (5), and wherein the acoustic navigating instructions can be transmitted to the radio receiver (6) by means of the transmitting device (4).

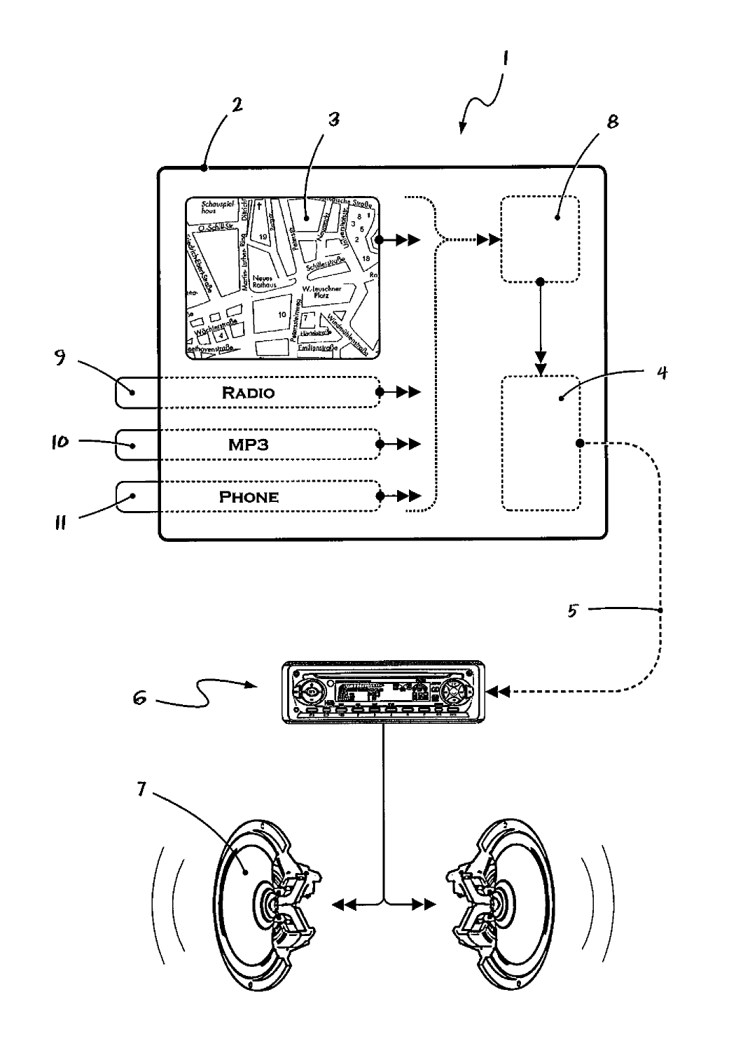

The invention pertains to a portable navigation system for a motor vehicle with a radio transmitter according to claim 1.

The market penetration of portable navigation systems or navigation devices continuously increases due to the improving capabilities of the devices and the decreasing prices. One frequent application of such portable navigation systems is the aftermarket installation or utilization in motor vehicles that were not equipped with a navigation system at the factory.

Modern navigation devices typically feature a touch-sensitive screen for operating the device as well as for displaying maps, wherein these navigation devices are furthermore equipped with a device for the acoustic output of spoken navigating instructions. The acoustic output of spoken navigating instructions is advantageous in that it creates the least distractions possible for the driver during the navigation.

The output of spoken navigating instructions, in particular, frequently results in a conflict of objectives with respect to the construction of navigation devices and with respect to the selection during the purchase by the customer. It would be desirable, in principle, to equip navigation devices with a comparatively voluminous housing, as well as a relatively powerful loudspeaker, in order to also output the acoustic navigating instructions in a clearly intelligible fashion while driving. However, thusly designed navigation devices conflict with the equally desirable portability of the devices for the customer, particularly the option of carrying along the navigation devices outside the motor vehicle, for example in a pocket of a jacket, on a bicycle or the like.

Based on these circumstances, the present invention aims to develop a portable navigation system that eliminates the aforementioned disadvantages of the state of the art. The invention furthermore should make it possible, in particular, to also ensure a flawless and clearly intelligible acoustic output of spoken navigating instructions while driving a motor vehicle despite possibly minimal housing dimensions of the navigation device.

This objective is attained with the navigation system according to claim 1.

Preferred embodiments of the invention form the objects of the dependent claims.

The navigation system according to the present invention is designed as a conventional portable navigation system, i.e., this navigation system is not intended for the fixed installation in a motor vehicle at the factory.

A conventional navigation system also typically comprises a device for generating acoustic or spoken navigating instructions.

According to the invention, however, the navigation system is characterized in that the navigation device features a transmitting device for generating radio signals. In this case, the acoustic or spoken navigating instructions can be transmitted from the navigation device to the radio receiver by means of the transmitting device and therefore reproduced with the aid of the on-board loudspeakers of the radio receiver or the motor vehicle, respectively.

In other words, the navigation device for acoustically reproducing the spoken navigating instructions in the motor vehicle is no longer dependent on its own amplifier and loudspeakers which would inevitably have to be comparatively small in most instances for constructive reasons.

The invention, in contrast, makes it possible to decisively increase and improve the quality, the volume and the intelligibility of the spoken navigating instructions due to the wireless transmission of the navigating instructions to the radio receiver of the motor vehicle by the radio transmitter of the navigation device—and due to the associated reproducibility of the spoken navigating instructions by means of the loudspeakers that were installed in the motor vehicle at the factory or by the vehicle owner.

The invention therefore makes it possible to either completely eliminate amplifiers and loudspeakers in navigation devices or to design the amplifiers and loudspeakers of the navigation devices in a very small and space-saving fashion (for example, for use outside the motor vehicle). The dimensions and weights of navigation devices therefore can be significantly reduced due to the invention such that a superior portability of the corresponding devices is achieved.

In this respect, the user should not have to make any compromises with respect to the utility value of the navigation device in the motor vehicle, wherein the invention even makes it possible to significantly increase this utility value. The invention furthermore makes it possible to reduce the number of components and therefore the costs for the construction of navigation devices, as well as the energy consumption of portable navigation devices so as to extend the battery life of the devices.

According to further embodiments of the invention, the navigation system not only comprises the acoustic output of spoken navigating instructions, but also other audio sources such as, for example, devices for reproducing digital music files (*.MP3 and the like) or can be connected to other audio sources, respectively.

This is advantageous because not only the spoken navigating instructions, but also other audio sources can be easily and comfortably controlled with one and the same device and one and the same user interface of the navigation device.

Based on these circumstances, another embodiment of the invention proposes that the navigation device can also be connected to a mobile telephone or that the navigation system features an installed telephone function. Due to this measure, the mobile telephone can also be controlled from the comfortable user-interface of the navigation device or the loudspeakers installed in the motor vehicle can be used for realizing a particularly clear acoustic reproduction of the conversational partner—in the sense of a hands-free device.

According to one particularly preferred embodiment of the invention, the navigation system can furthermore be connected to an additional radio receiver or features its own additional radio receiver. This embodiment is particularly advantageous in that the complete radio program can be controlled from the comfortable user interface of the navigation device. In other words, according to this embodiment, the choice of station, volume adjustment, traffic radio broadcast, etc., can be entirely controlled by the navigation device itself or on the touchscreen of the navigation device.

In this embodiment of the invention, the radio device installed in the motor vehicle is merely utilized as a component of the transmission path and as a means for reproducing the acoustic signals transmitted in a wireless fashion by the navigation device with the aid of the loudspeakers. This particular embodiment of the invention is also practical in that modern navigation devices are frequently equipped with a radio receiver anyhow in order to evaluate the TMC data channel with respect to traffic jam announcements and the like.

Based on these circumstances, another particularly preferred embodiment of the invention proposes that the navigation system is designed for automatically varying the volume of the additional audio sources. This embodiment provides the advantage that the volume of the additional audio sources, particularly the currently playing music or radio program, can be automatically lowered or muted by the navigation device as soon as spoken navigating instructions should be acoustically output on the loudspeakers of the vehicle.

This eliminates one frequently encountered problem inherent to the state of the art, namely that the car radio continues to play with the same volume—during the output of spoken navigating instructions by the navigation device—such that the navigating instructions are difficult to understand and the concentration of the driver may be diverted and impaired.

According to another embodiment of the invention, the navigation system features a device for the intermediate storage of audio signals. This embodiment provides the additional advantage that audio signals, particularly traffic announcements, can be temporarily stored during the reproduction of navigating instructions and reproduced with a certain time delay.

For example, a traffic announcement can be temporarily stored and reproduced with a certain time delay if navigating instructions of the navigation device are reproduced during the broadcast of a traffic announcement. This prevents the driver from being distracted or confused by the simultaneous reproduction of navigating instructions and traffic announcements. In addition, this embodiment ensures that the driver does not miss a possibly important traffic announcement due to the fact that the volume of the car radio is muted during a traffic announcement due to the acoustic output of navigating instructions.

The invention can be realized regardless of the constructive design and the arrangement of the transmitting device of the navigation system. For example, the transmitting device may be installed into the housing of the navigation system. According to an alternative embodiment of the invention, however, the transmitting device features its own housing and can be connected to the navigation system in a wired or wireless fashion. This results in a particularly flexible arrangement of the navigation system and the transmitting device in the motor vehicle. For example, the transmitting device can thusly be arranged in the vicinity of the car radio antenna such that the transmitting device only requires an extremely low transmitting power and possible electromagnetic interferences caused by the transmitting device can be minimized.

According to another embodiment of the invention, the transmitting device is designed for generating digital radio signals. In other words, the radio signals generated by the transmitting device conform to current and future radio broadcasting standards such as, for example, DAB or DVB-T. Due to this measure, the transmitting device and the navigation device can also be used in connection with corresponding digital radio receivers.

According to another preferred embodiment of the invention, the navigation system comprises a battery power supply. This enables the user to very easily utilize the navigation system, for example, in different motor vehicles, and the navigation system is also suitable as a navigation aid, for example for pedestrians, bicyclists or motorcyclists—due to the elimination of a voluminous housing and loudspeakers in accordance with the invention.

The invention is described in greater detail below with reference to the only embodiment illustrated in the drawing.

The Single FIGURE shows a schematic representation of one embodiment of an inventive navigation system that is not illustrated true-to-scale.

The FIGURE shows a highly schematic representation of one embodiment of a navigation system for a motor vehicle that is definitely not illustrated true-to-scale.

The symbolically illustrated navigation system 1 comprises, in particular, a housing 2 and a navigation computer 3, for example with a monitor. According to the invention, the navigation system 1 furthermore comprises a transmitting device 4 for generating and modulating radio signals 5.

The radio signals 5 are transmitted in a wireless fashion to a car radio 6 installed in the motor vehicle such that the modulation content of the radio signals 5 can be reproduced by the car radio 6 with the aid of the vehicle loudspeakers 7.

In the embodiment of the navigation system 1 illustrated in the FIGURE, the transmitting device 4 is accommodated in the housing 2 of the navigation system 1. However, in other embodiments of the inventive navigation system 1, the transmitting device 4 may also be arranged separately of the housing 2 of the navigation system 1, particularly in its own housing. In this case the connection between the navigation system 1 and the transmitting device 4 may be realized in a wired or wireless fashion, for example with the aid of a Bluetooth radio link.

In order to modulate the radio signals 5, the navigation system 1 shown furthermore comprises a signal converter 8 for converting the audio signals of various audio sources 3, 9, 10, 11 and forwarding the converted audio signals to the transmitting device.

In the embodiment shown, the audio sources include the navigation computer 3 with the spoken navigating instructions generated therein. The exemplary navigation system 1 shown furthermore comprises its own radio receiver 9, an MP3 player 10 and a hands-free device 11.

The various audio sources consisting of the radio receiver 9, the MP3 player 10 and the hands-free device 11 are illustrated as partially protruding over the boundary of the housing 2 of the navigation system 1 in order to symbolize that these audio sources may be installed in the navigation system 1 or realized in the form of auxiliary modules to be inserted into the navigation system. However, the audio sources may also consist of external audio sources 9, 10, 11 that can be connected to the navigation system 1, for example, by means of corresponding audio cables or in a wireless fashion.

The connection of all audio sources 3, 9, 10, 11 by means of the navigation system 1 provides the advantage of an intelligent control of all audio sources, particularly in dependence on the instantaneous status of the navigation system 1. For example, this makes it possible for the navigation system 1 to mute the respectively active audio sources 3, 9, 10, 11, if so required, and to respectively stop or intermediately store the active audio sources as long as acoustic navigating instructions are output. Navigating instructions that are difficult to understand as well as confusion of the driver due to several audio sources that are simultaneously active can be effectively precluded in this fashion.

The previous description makes it clear that the quality of the speech output of portable navigation devices can be decisively improved—with respect to a sufficient volume and an improved intelligibility while driving—by means of the invention. In addition, the invention makes it possible to eliminate one problem inherent to the state of the art, namely the impaired intelligibility of navigation announcements caused by other audio sources in the motor vehicle. The dimensions and weights of navigation devices can be reduced due to the elimination of a voluminous housing and loudspeakers in accordance with the invention such that the portability and the universal utilization of the corresponding devices are improved. The invention furthermore makes it possible to reduce the number of components and therefore the manufacturing costs, as well as the energy consumption of portable navigation devices.

The invention consequently provides an important contribution to improving the user-friendliness and safety of portable navigation devices used, in particular, in motor vehicles.

1. A portable navigation system (1) for a motor vehicle with a radio receiver (6), wherein the navigation system (1) comprises a device (3) for generating acoustic navigating instructions,
characterized in that
the navigation system (1) features a transmitting device (4) for generating radio signals (5), wherein the acoustic navigating instructions can be transmitted to the radio receiver (6) by means of the transmitting device (4).

2. The navigation system according to claim 1,
characterized in that
the navigation system (1) features additional audio sources (9, 10, 11).

3. The navigation system according to claim 1,
characterized in that
the navigation system (1) can be connected to additional audio sources (9, 10, 11).

4. The navigation system according to claim 1,
characterized in that
the navigation system (1) can be connected to a mobile telephone (11) or features an installed mobile telephone function (11).

5. The navigation system according to claim 1,
characterized in that
the navigation system (1) can be connected to an additional radio receiver (9) or features an additional radio receiver (9).

6. The navigation system according to claim 2,
characterized in that
the navigation system (1) is designed for automatically varying the volume of the additional audio sources (9, 10, 11).

7. The navigation system according to claim 2,
characterized in that
the navigation system (1) comprises a device for intermediately storing audio signals.

8. The navigation system according to claim 1,
characterized in that
the transmitting device (4) features its own housing and can be connected to the navigation system (1) in a wired or wireless fashion.

9. The navigation system according to claim 1,
characterized in that
the transmitting device (4) is designed for generating digital radio signals (5).

10. The navigation system according to claim 1,
characterized in that
the navigation system (1) comprises a battery power supply.
